(19) United States
(12) Patent Application Publication
(10) Pub. No.: US 2013/0301248 A1
(43) Pub. Date: Nov. 14, 2013

(54) CHRISTMAS TREE ORNAMENT

(71) Applicants: Pamela Gibbs, Williamson, GA (US); John Gibbs, Williamson, GA (US)

(72) Inventors: Pamela Gibbs, Williamson, GA (US); John Gibbs, Williamson, GA (US)

(21) Appl. No.: 13/469,019

(22) Filed: May 10, 2012

(51) Int. Cl. F21S 8/06; F21S 4/00; F21V 17/10; F21V 21/00

(52) U.S. Cl. 362/147; 362/249.19; 362/249.17; 362/249.02

(57) ABSTRACT

The present invention is a Christmas tree ornament that includes a base ornament that is generally star-shaped, a plurality of metal rods that are disposed along a perimeter of the base ornament and an attachment string that is disposed on top of the base ornament that is tied to a stationary object or an area. The Christmas tree ornament also includes a plurality of mini lights that are disposed throughout the outer surface of the base ornament that serve as a decorative feature and a plurality of tinsel that is disposed throughout the outer surface of the base ornament that serves as an additional decorative feature.

### TECHNICAL FIELD & BACKGROUND

During the month of December many homes are decorated with an artificial or real tree to place presents under for Christmas. There are not many items that can replace a Christmas tree for a family that desires to have a non-traditional celebration.

The present invention generally relates to an ornament. More specifically, the invention is a Christmas tree ornament.

It is an object of the invention to provide a Christmas tree ornament that is suspended from a ceiling and serves as a Christmas tree for a user to place Christmas presents under.

It is an object of the invention to provide a Christmas tree ornament that provides a relatively meaningful Bible reference.

What is really needed is a Christmas tree ornament that is suspended from a ceiling and serves as a Christmas tree for a user to place Christmas presents under that provides a relatively meaningful Bible reference.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a Christmas tree ornament, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

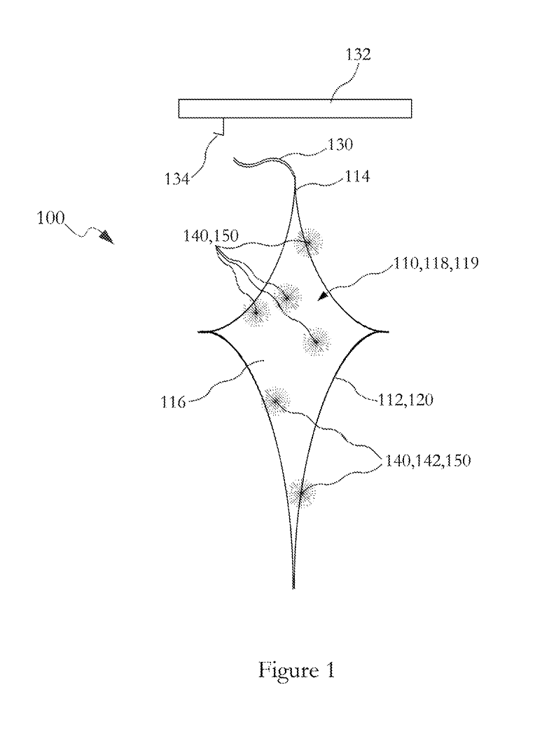

FIG. 1 illustrates a front view of a Christmas tree ornament 100, according to an embodiment of the present invention.

The Christmas tree ornament 100 includes a base ornament 110 with a perimeter 112, a top 114 and an outer surface 116, a plurality of metal rods 120, an attachment string 130, a plurality of mini lights 140 and a plurality of tinsel 150. The base ornament 110 is generally star-shaped 118 and represents a Star of David symbol 119 or can be any other suitable generally star-shaped symbol. The metal rods 120 are relatively small in diameter and are disposed along the perimeter 112 of the base ornament 110. The attachment string 130 is disposed on the top 114 of the base ornament 110 and can be tied to any suitable stationary object or area such as a ceiling support 132 or a hook 134. The mini lights 140 are disposed throughout the outer surface 116 of the base ornament 110 that serve as a decorative feature and can be any suitable lights such as a plurality of LED lights 142. The tinsel 150 is also disposed throughout the outer surface 116 of the base ornament 110 that serves as an additional decorative feature. The mini lights 140 and tinsel 150 can be disposed in any orientation or positioning on the outer surface 116 of the base ornament 110.

There are not many items that can replace a Christmas tree for a family that desires to have a non-traditional celebration. The Christmas tree ornament is a suitable alternative to one or more standard seasonal ornaments. The Christmas tree ornament weighs approximately 10 pounds and includes a plurality of small perimeter metal rods. Intended for use indoors, this approximately 6 feet tall and 3 feet wide Christmas tree ornament can be hung and decorated with a plurality of mini lights and silver tinsel. Suspended from a ceiling by a hook or tied to a ceiling support, presents and other suitable gift items can be placed underneath the Christmas tree ornament. The Christmas tree ornament may be readily available for purchase at retail stores where decorations are sold. The Christmas tree ornament features a large multi-dimensional, holiday decoration. The Christmas tree ornament is also designed to be easily separated and folded down for quick and easy storage.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1.-7. (canceled)

8. A Christmas tree ornament, comprising:
a base ornament with a perimeter, a top and an outer surface that is generally star-shaped;
a plurality of metal rods that is disposed along said perimeter of said base ornament;
an attachment string that is disposed on said top of said base ornament that is adapted to be tied to a ceiling in a manner which allows the base ornament to be suspended from the ceiling;
a plurality of mini lights that are disposed throughout said outer surface of said base ornament that serve as a decorative feature; and
a plurality of tinsel that is disposed throughout said outer surface of said base ornament that serves as an additional decorative feature.

9. The Christmas tree ornament according to claim 8, wherein said generally star shape represents a Star of David symbol.

10. The Christmas tree ornament according to claim 8, wherein said mini lights are a plurality of LED lights.

11. (canceled)

12. The Christmas tree ornament according to claim 8, wherein said attachment string is adapted to be tied to the ceiling through a ceiling support.

13. The Christmas tree ornament according to claim 8, wherein said attachment string is adapted to be tied to the ceiling through a hook.

14. The Christmas tree ornament according to claim 8, wherein:
said Christmas tree ornament weighs approximately 10 pounds; and
said Christmas tree ornament is approximately 6 feet tall.

15. A Christmas tree ornament, comprising:
a base ornament with a perimeter, a top and an outer surface that is generally star-shaped;
a plurality of metal rods that is disposed along said perimeter of said base ornament;
an attachment string that is disposed on said top of said base ornament that is adapted to be tied to a ceiling in a manner which allows the base ornament to be suspended from the ceiling;
a plurality of mini LED lights that are disposed throughout said outer surface of said base ornament that serve as a decorative feature; and
a plurality of tinsel that is disposed throughout said outer surface of said base ornament that serves as an additional decorative feature.

16. The Christmas tree ornament according to claim 15, wherein said generally star shape represents a Star of David symbol.

17. (canceled)

18. The Christmas tree ornament according to claim 15, wherein said attachment string is adapted to be tied to the ceiling through a ceiling support.

19. The Christmas tree ornament according to claim 15, wherein said attachment string is adapted to be tied to the ceiling through a hook.

20. The Christmas tree ornament according to claim 15, wherein:
said Christmas tree ornament weighs approximately 10 pounds; and
said Christmas tree ornament is approximately 6 feet tall and is approximately 3 feet wide.
